(19) United States
(12) Patent Application Publication
(10) Pub. No.: US 2005/0231356 A1
(43) Pub. Date: Oct. 20, 2005

(54) Hands-free portable receiver assembly for use with baby monitor systems

(76) Inventors: Danny Roy Bish, Kernersville, NC (US); Robert Edward Whewell, Charlotte, NC (US)

Correspondence Address: DOROTHY S. MORSE, 515 PARK DRIVE, NW, BRADENTON, FL, 34209, US

(21) Appl. No.: 11/098,968

(22) Filed: Apr. 5, 2005

Related U.S. Application Data
(60) Provisional application No. 60/559,483, filed on Apr. 5, 2004.

(51) Int. Cl. G08B 1/08

(52) U.S. Cl. 340/539.1; 340/573.1; 455/73

(57) ABSTRACT

A hands-free, portable receiver assembly for use with the transmitters of a broad range of baby monitoring systems. It comprises a small lightweight frequency receiver unit adaptable for picking up the transmitted baby monitoring system signals, either through use of a frequency detector, or as a result of the well-known or commonly used baby monitoring frequencies being programmed into the receiver unit whereby its operator is able to manually match the receiver unit frequency to that of the baby monitoring system selected for use. The receiver unit may have any configuration that can be conveniently worn by the operator for hands-free use, such as but not limited to a writing implement, pager, or piece of jewelry, or an all-inclusive stand-alone earpiece. Such an earpiece can have a built-in speaker, or an ear bud housing having a speaker that communicates with the earpiece via electrical wiring or otherwise.

### CROSS-REFERENCES TO RELATED APPLICATIONS

The following utility patent application relates back to provisional patent application No. 60/559,483, filed on Apr. 5, 2004 by both applicants herein for substantially the same subject matter. Thus, the applicants herein claim all benefit to which they are entitled as a result of the above-identified U.S provisional patent application.

### BACKGROUND OF THE INVENTION

1. Field of the Invention

The present invention relates to baby monitoring systems, specifically to an assembly configured for use with the transmitters of a broad range of baby monitoring systems. It comprises a small and lightweight frequency receiver unit that is adaptable for alternatively picking up the signals transmitted from different types of baby monitoring systems, either through use of a frequency detector, or as a result of the well-known or commonly used baby monitoring system frequencies being programmed by the manufacturer into the receiver unit whereby its operator can manually match the receiver unit frequency to that of the baby monitoring system selected for use. The receiver unit may have any lightweight and mobile housing configuration that can be conveniently worn by the operator for hands-free use, such as but not limited to that of a pager, writing implement, or piece of jewelry. Each would have an optional earpiece. In the alternative, the housing of the receiver unit could be in the form of an all-inclusive stand-alone earpiece. When an earpiece is configured to pick up the transmitted signal from the baby monitoring system, the signal can be forwarded to the operator via a speaker built into the earpiece, a speaker in an ear bud attached to the earpiece via electrical wiring, or a speaker in an ear bud attached to the earpiece wherein the ear bud has a means other than electrical wiring for communicating with the earpiece to receive the signaled information that the earpiece picks up from the baby monitoring system.

2. Description of Related Art

Baby monitoring systems are commonly used when a parent needs to temporarily be in a location remote from a baby or young child, such as when the baby or child is placed for a nap into a secluded bedroom that is purposefully distanced from the noise of siblings and/or other household activity. Such systems are also used by people attending to the injured, disabled, elderly, or infirm, and typically comprise a stationary transmitter unit that is placed near the baby or person for whom audio monitoring is required, and a portable receiver unit that is carried by the person performing the monitoring function. The paired transmitter and receiver units communicate with one another at a factory-set frequency. When the monitoring person stays substantially in the same location during the entire monitoring period, the original receiver unit can conveniently remain in one nearby location. However, the monitoring person often performs a multitude of activities during the monitoring period that requires movement between different rooms in a house, and each time the monitoring person moves from one room into another, he or she must remember to pick up the receiver unit and transport it to the next location. Although there are a few small portable receiver units available for use, such as the invention disclosed in U.S. Pat. No. 5,512,880 to Abrams (1996) that can be alternatively placed in a stand or strapped to the wrist of the monitoring person, most monitoring system receiver units are sufficiently large that they cannot be conveniently carried or comfortably worn by the user. Also, even when smaller receiver units such as the Abrams device are available, they operate only with one brand or model of monitoring system and are not alternatively usable at different frequencies with different systems. No diminutive and conveniently transported receiving unit is known to be adaptable for use with a broad range of baby monitoring systems, or have all of the features and advantages of the present invention.

### BRIEF SUMMARY OF THE INVENTION—OBJECTIVES AND ADVANTAGES

The primary object of this invention is to provide a baby monitoring system receiving unit assembly that is diminutive in size for easy transport by a person needing to monitor another in a remote location. It is also an object of this invention to provide a receiving unit assembly that is usable with a broad range of baby monitoring systems. A further object of this invention is to provide a receiving unit assembly of sturdy construction that is durable and easy to use. It is also an object of this invention to provide a receiving unit assembly having a means of signaling the user when it is no longer able to pick up a signal and/or when available power for continued operation is low.

As described herein, properly manufactured and used, the receiving unit assembly of present invention would have a small and lightweight housing, such as but not limited to the configuration of a pager, writing implement, or piece of jewelry, that would be comfortably and unobtrusively worn by a person needing to temporarily monitor another in a remote location. It can also be configured with an optional earpiece, or be provided in the form of an all-inclusive stand-alone earpiece. The present invention can be used with the transmitters of a broad range of baby monitoring systems, since it either comprises a frequency detector or has a vast majority of the well-known or commonly used baby monitoring system frequencies programmed into it by its manufacturer which an operator can use to manually obtain a match between the frequency of the baby monitoring system selected for use and the present invention. The most preferred embodiments of the present invention comprise a speaker, a frequency detector button, a power/volume control, a processor, a jack for earpiece connection, speaker/earpiece switch, a low-power/out-of-range indicator, a clothing or belt attachment device, and a source of battery power. Optionally, the earpiece can be self-winding and/or secured within a separate housing detachable from the main receiver housing. Should infrared or other means of signal detection be used in future baby monitoring systems, the present invention would be adaptable for use with such systems. For additional convenience, the present invention could also optionally include a locator mechanism that would provide a visual and/or audio signal in response to a command of the user. When the all-inclusive stand-alone earpiece is configured to pick up the transmitted signal from the baby monitoring system, the signal can be forwarded to the operator via a speaker built into the earpiece, a speaker in an ear bud attached to the earpiece via electrical wiring, or a speaker in an ear bud attached to the earpiece wherein the ear bud has a means other than electrical wiring for communicating with the earpiece to receive the signaled information that the earpiece picks up from the baby monitoring system. No receiving unit for use with baby monitoring systems is known that has all of the features and advantages of the present invention.

The description herein provides the preferred embodiments of the present receiving unit invention but should not be construed as limiting its scope. For example, variations in the shape of the housing; the type of earpiece used; the location of the components within the housing; the use of an attached housing for the earpiece; and the attachment means used by which a user can secure the receiving unit to clothing or a belt; other than those shown and described herein may be incorporated into the present invention. Thus, the scope of the present invention should be determined by the appended claims and their legal equivalents, rather than being limited to the examples given herein.

### BRIEF DESCRIPTION OF THE SEVERAL VIEWS OF THE DRAWINGS

FIG. 1 is a sectional view of a first preferred embodiment of the present invention having a speaker and frequency detector.

FIG. 2 is a sectional view of a second preferred embodiment of the present invention having a detachable housing within which a self-winding earpiece can be stored.

FIG. 3 is a sectional view of a third preferred embodiment of the present invention having a detachable housing within which a self-winding earpiece can be stored and an LED screen for displaying frequency codes during the step of synchronizing the receiving unit frequency to that of the signal transmitted by the baby monitoring system.

FIG. 4 is a sectional view of the most preferred embodiment of the detachable housing and self-winding earpiece in the present invention.

FIG. 5 is a perspective view of the first preferred embodiment of the present invention showing the rear, top, and left side of the present invention configured as a pager with a rear clip-like fastener configured for attachment to a belt or clothing.

FIG. 6 is a perspective view of the first preferred embodiment of the present invention showing the front, top, and left side of the present invention configured as a pager.

FIG. 7 is a perspective view of the second preferred embodiment of the present invention showing the front, top, and right side of the present invention configured as a pager wherein the right side shows the opening used for connection of the detachable housing containing a self-winding earpiece to the pager housing.

FIG. 8 is a perspective view of the second preferred embodiment of the present invention showing the front, top, and right side of the present invention configured as a pager with the detachable housing for a self-winding earpiece secured against the bottom surface of the pager housing.

FIG. 9 is a perspective view of the second preferred embodiment of the present invention showing the rear, top, and left side of the present invention configured as a pager and showing a detachable housing for a self-winding earpiece secured against the bottom surface of the pager housing.

FIG. 10 is a perspective view of the second preferred embodiment of the present invention showing the front, top, and left side of the present invention configured as a pager and showing a detachable housing for a self-winding earpiece secured against the bottom surface of the pager housing.

FIG. 11 is a perspective view of the third preferred embodiment of the present invention showing the front, top, and right side of the present invention configured as a pager with an LED display, and showing a detachable housing for a self-winding earpiece secured against the bottom surface of the pager housing.

FIG. 12 is a sectional view of a fourth preferred embodiment of the present invention configured as a stand-alone earpiece wherein the portion attached to the ear is separated from the main body housing via a sound channel.

FIG. 13 is a perspective view of a fifth preferred embodiment of the present invention configured as a writing implement.

FIG. 14 is a perspective view of a sixth preferred embodiment of the present invention configured as a piece of jewelry.

FIG. 15 is a sectional view of an earpiece having a radio transmission receiver and internal speaker that is allow it to be used with the sixth preferred embodiment of the present invention.

### DETAILED DESCRIPTION OF THE INVENTION

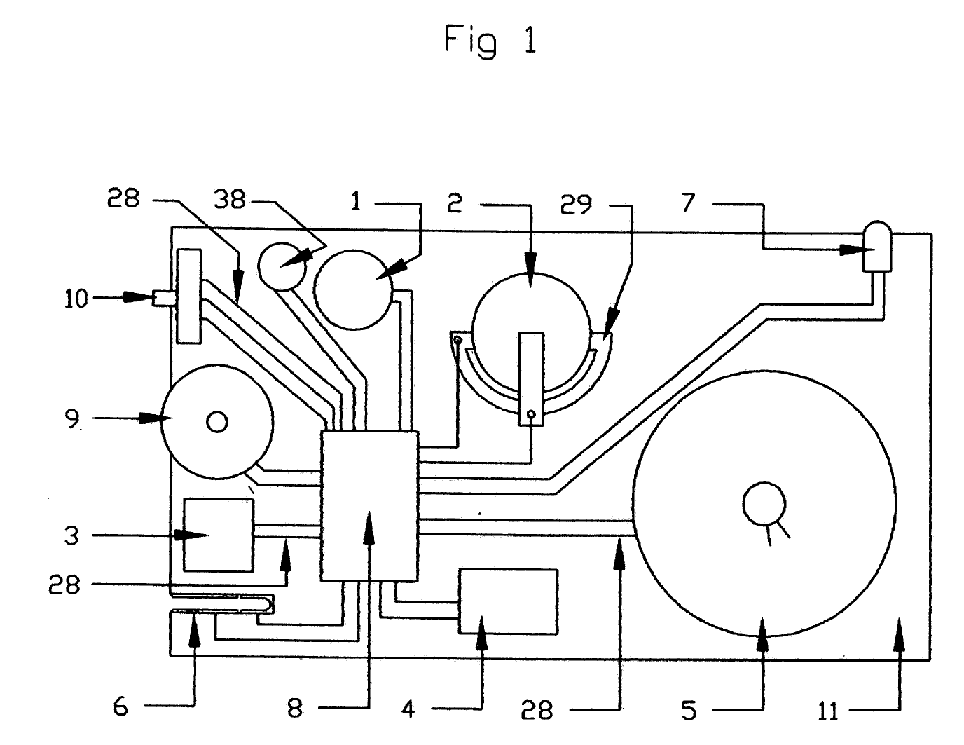

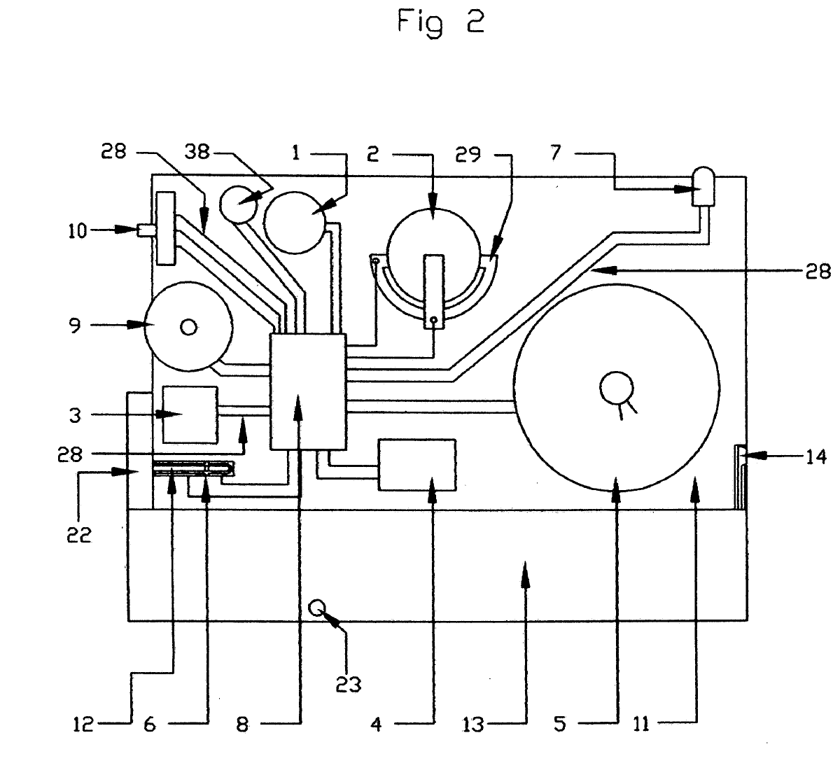

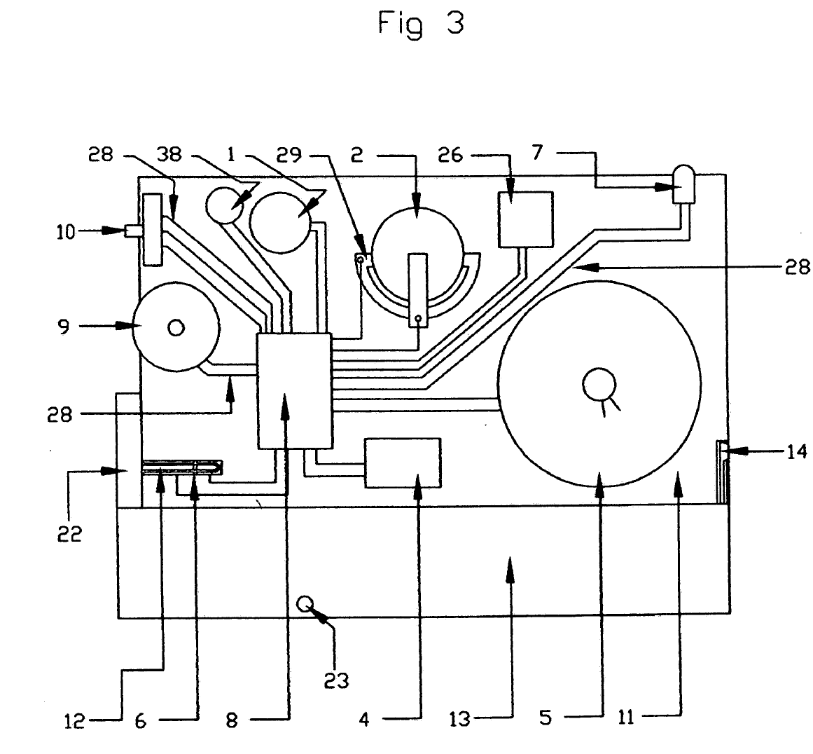

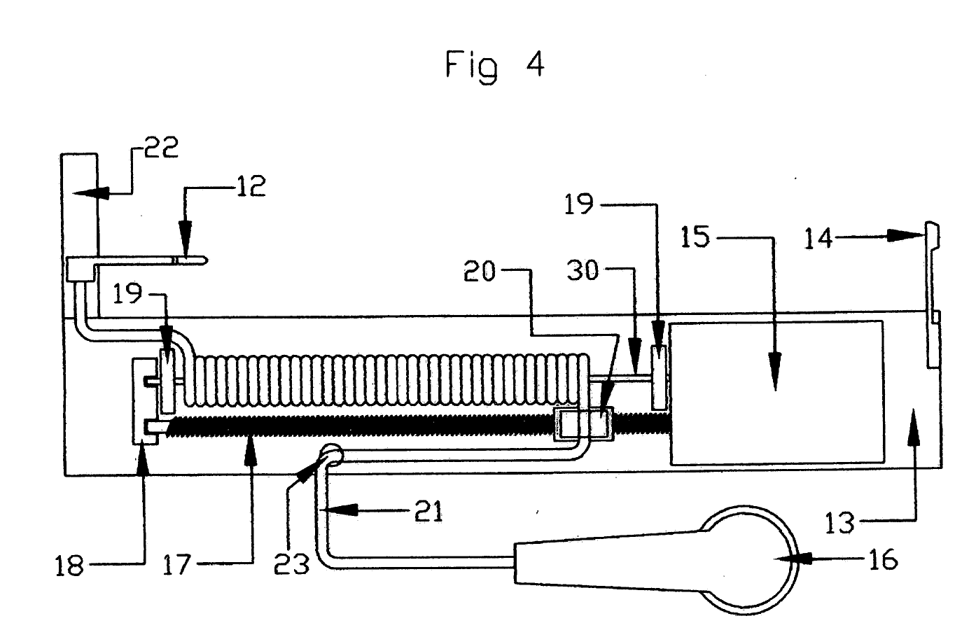

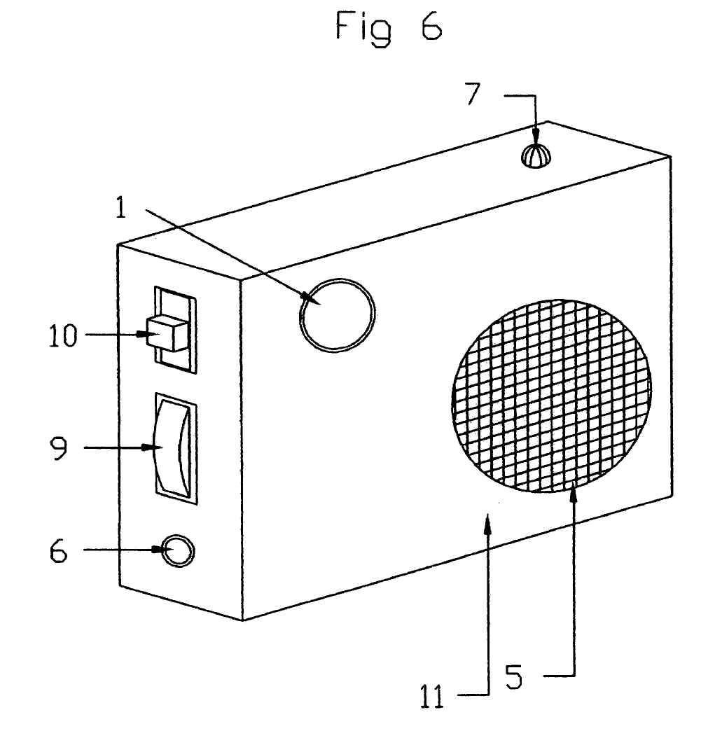

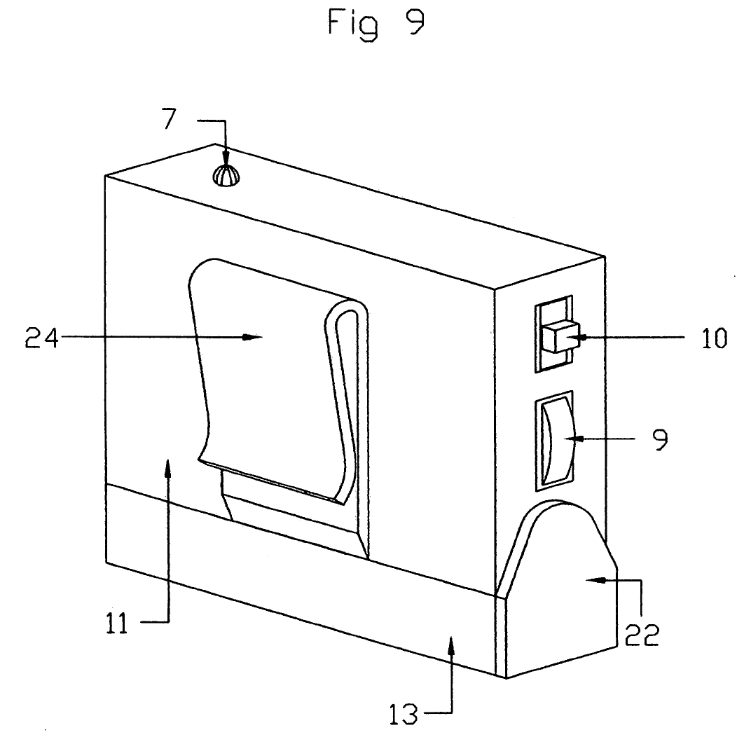

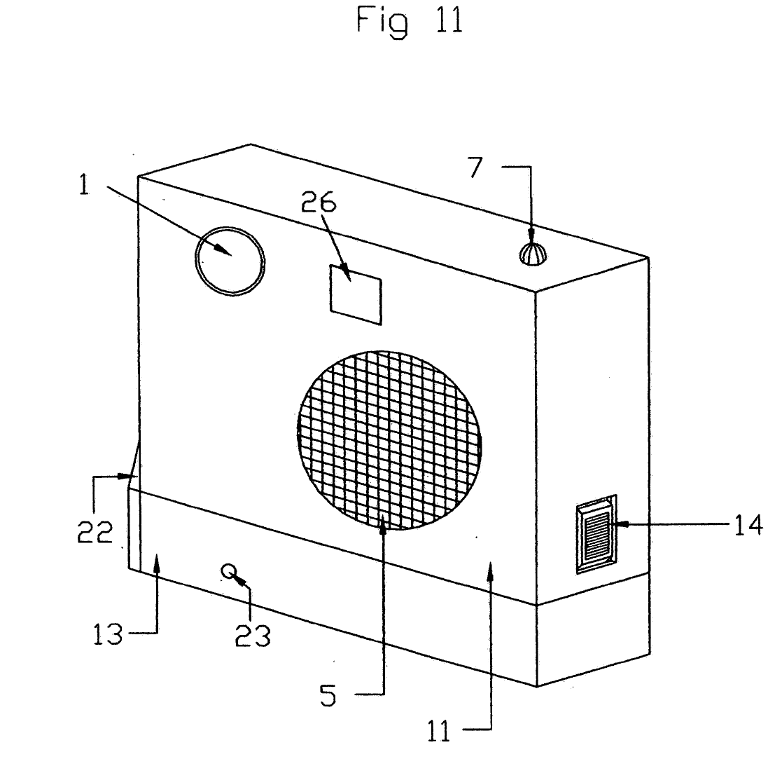

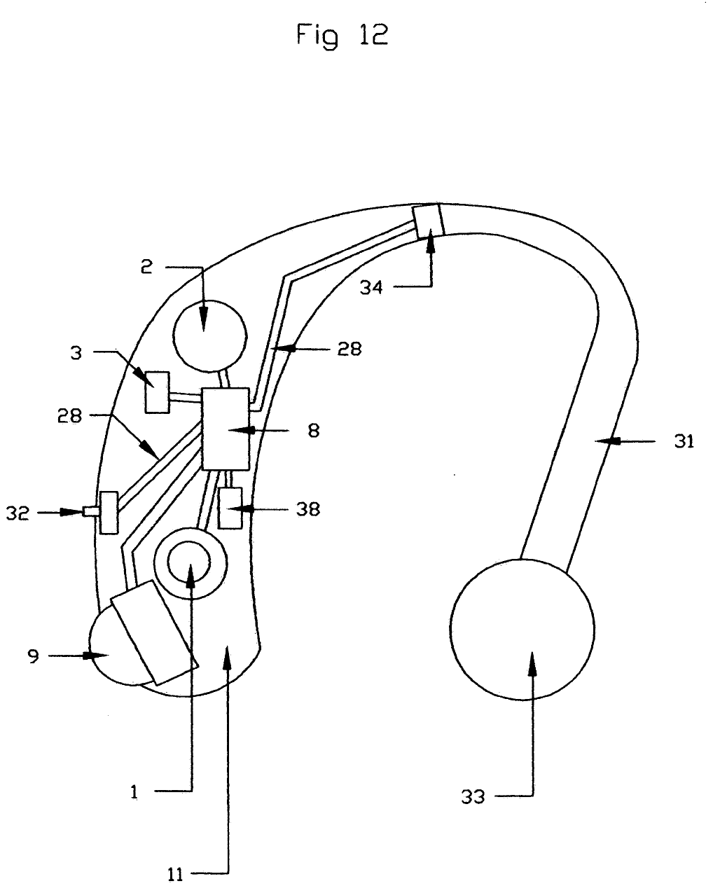

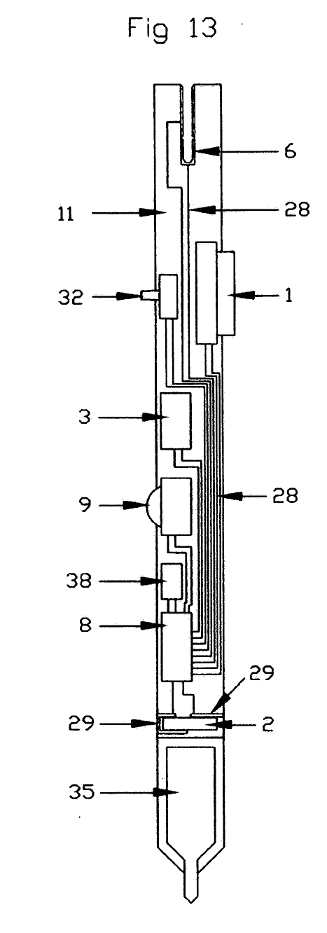

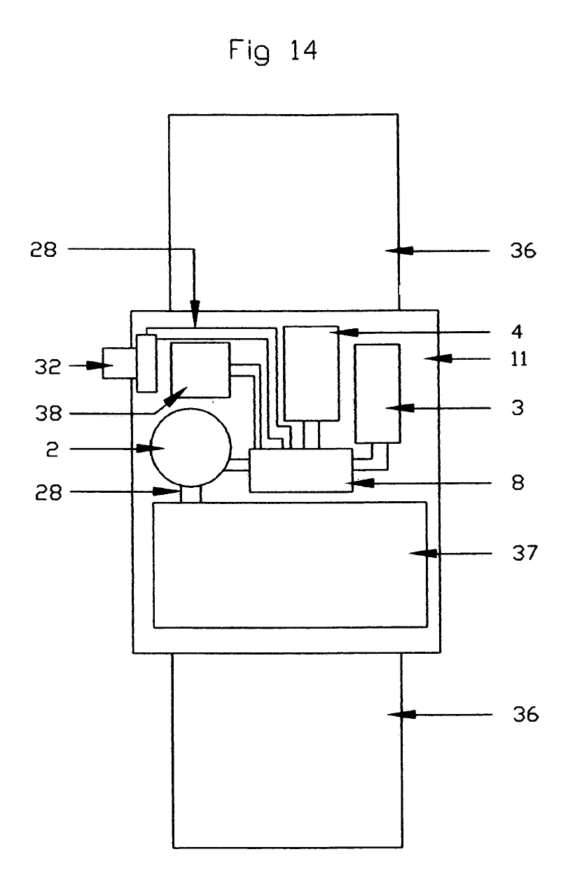

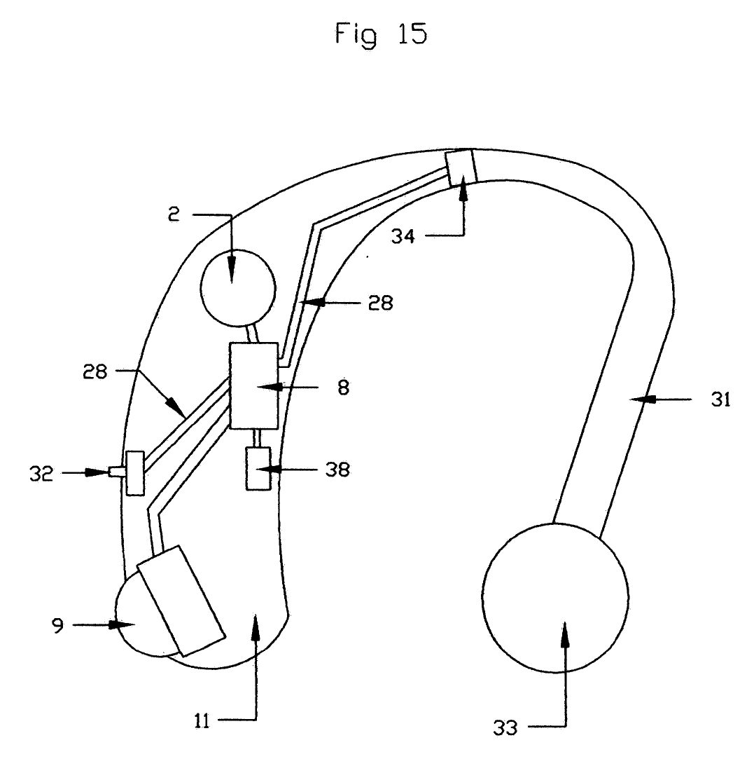

FIGS. 1-15 show six preferred embodiments of the hands-free and easily portable receiver unit of the present invention that is contemplated for use with the transmitters of a broad range of baby monitoring systems. However, it should be noted that other variations and combinations of features are also possible without departing from the overall intent of the present invention. Therefore, the scope of the present invention should be determined by the appended claims and their legal equivalents, rather than being limited to the examples given. FIGS. 1, 5, and 6 show the first preferred embodiment of the present invention in the form of a pager having a speaker 5, frequency detector 3, and radio transmission receiver 38, whereby automatic frequency synchronization of the hands-free and easily portable receiver unit to the transmitter of the baby monitoring system selected for use therewith can be achieved simply by operator activation of an easily accessible frequency detector button 1. FIGS. 2, and 7-10 show the second preferred embodiment of the present invention in the form of a pager having a detachable housing 13 for a self-winding earpiece, such as that shown in FIG. 4. The second preferred embodiment also has speaker 5, frequency detector 3, and radio transmission receiver 38, that allows for automatic frequency synchronization of the receiver unit to the transmitter of a baby monitoring system via operator activation of a frequency detector button 1. FIGS. 3 and 11 show the third embodiment of the present invention in the form of a pager having a detachable housing 13 within which a self-winding earpiece can be stored and an LED screen 26 for displaying frequency codes during manual synchronization of one of the frequencies pre-programmed into the receiving unit to that of the signal transmitted by the baby monitoring system. The operator may be given a list of frequencies commonly used by various manufacturers of baby monitoring systems as a reference. Prior to use, the operator must manually select a frequency matching that of the baby monitoring system selected for use. FIGS. 12-14 shows alternative housing configurations. FIG. 12 shows the fourth preferred embodiment of the present invention configured as a stand-alone earpiece, while FIGS. 13 and 14, respectively the fifth and sixth preferred embodiments of the present invention, are configured as a writing implement and a piece of jewelry. FIG. 15 shows an earpiece with a radio transmission receiver and internal speaker that allow it to be used with the sixth jewelry-shaped preferred embodiment. Although not shown, other housing configurations are also contemplated by the present invention. Each should be lightweight and compact in design, and offer a means of convenient hands-free portability, that includes a fastening means adapted for attachment to the user or user's clothing, such as but not limited to the spring clip belt attachment device 24 shown in FIG. 9. While some embodiments of the present invention may be pre-programmed with frequencies commonly used by existing baby monitoring systems, other embodiments may comprise a frequency detector, as shown in FIG. 1 by the number 3. For the pre-programmed embodiments, such but not limited to that shown in FIG. 3, the operator may be given an instruction sheet that includes a list of baby monitor manufacturers and the frequencies they typically use. The operator would then start with the pre-programmed frequencies listed for the manufacturer of the baby monitoring system selected for use with the present invention, and proceed one at a time with other frequencies as needed, until the frequency corresponding to the selected baby monitoring transmitter is found. In contrast, to set receiver unit frequency in an embodiment of the present invention having a frequency detector, an operator simply has to position the receiver unit in the vicinity of the baby monitor selected for use and then hold down a button, such as frequency detector button 1 in FIGS. 1 and 6, until the frequency detector component (such as number 3 in FIG. 1) detects the frequency employed by that baby monitor transmitter. The frequency then remains at that setting, until the button is held down again in the vicinity of a baby monitor transmitter using a different frequency.

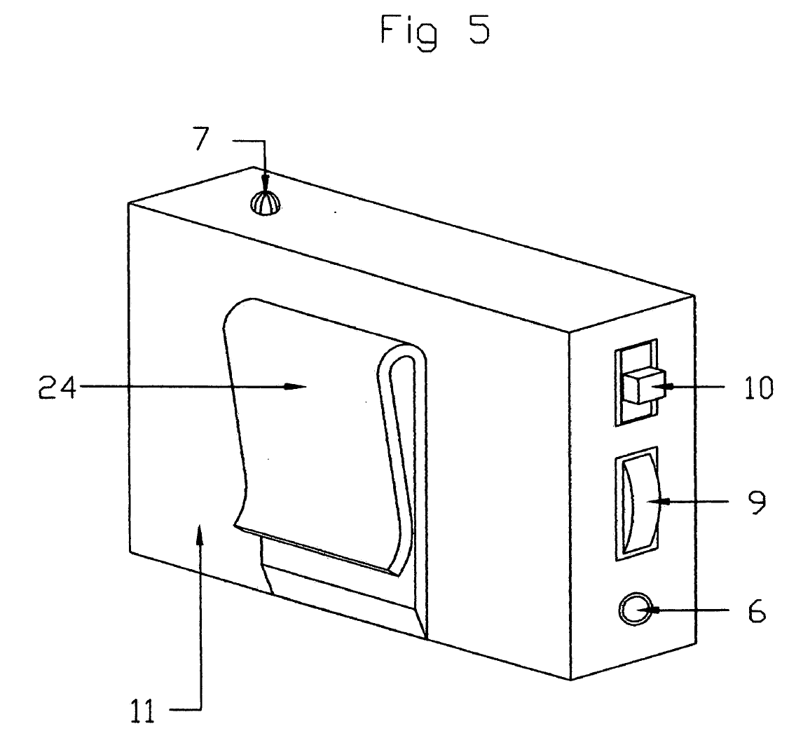

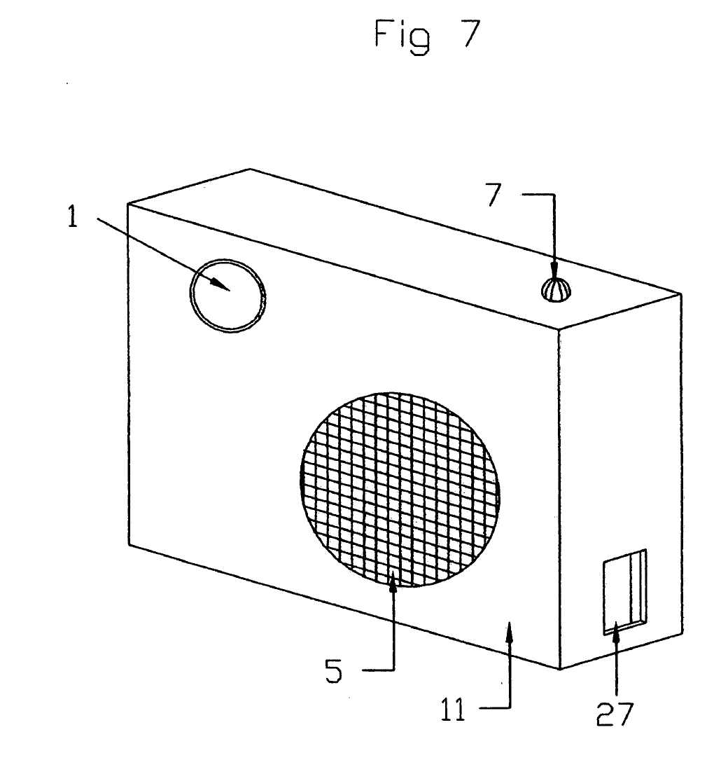

FIG. 1 shows a first preferred embodiment of the present invention with automatic frequency detection, a speaker/earphone jack 6, but no female fastening device 27 by which to connect a self-winding earpiece, such as that shown in FIG. 7. FIG. 1 shows the first preferred embodiment having a housing 11 in the configuration of a pager and having a battery 2, a speaker 5, a power indicator 7, a processor 8, a frequency detector activation button 1, a speaker/earpiece switch 10, a power/volume control 9, a frequency detector 3, and a radio transmission receiver 38. The arrangement of components within housing 11 is not critical, however, component placement should lend itself to cost effective manufacture and be suitable for optional attachment of a detachable earpiece, or a detachable housing 13 for a self-winding earpiece as shown in FIG. 2, where desired. FIGS. 5 and 6 also illustrate the first preferred embodiment, showing a configuration of exterior surfaces corresponding to the component configuration illustrated in FIG. 1. It is not contemplated for the configuration of housing 11 in the first preferred embodiment to be limited to that of a rectangle, and arcuate lines that add to the aesthetic appeal of the device are also considered to be a part of the present invention. Also, the circular representation of battery 2 is not intended to indicate any particular make or model of power supply, but to indicate a lightweight source of direct current power. Further, the configuration of battery mount 29 is not critical, as long as it securely holds battery 2 in its usable position during operation. Alternatively, battery 2 in the first preferred embodiment of the present invention may be rechargeable, and a charger may also be incorporated within housing 11 to periodically renew the available energy supply in battery 2. Although not shown, a separate charger component may be used. However, it is also contemplated for the power supply device represented by battery 2 to act as a charger when plugged into an external power source. It is also considered within the scope of the present invention for the component marked as battery mount 29 to be configured as a charger for battery 2. When a charger is incorporated within housing 11, a power jack and/or power converter would also be a functioning part of the present invention. Although speaker/earphone switch 10 and frequency detector button 1 both appear to have a depressible configuration, it is contemplated for speaker/earphone switch 10 and frequency detector button 1 to have other configurations, such as that of a sliding, rotatable, or toggle type of switch or button. However, for its compact design, although not shown, power/volume control 9 in the most preferred embodiment of the present invention would probably have the form of a rotatable disk with ridges on its outer edge for easy hand manipulation. Power indicator 7 is shown to be small in size relative to battery 2 and power/volume control 9. The relative size of battery 2 and power/volume control 9 to power indicator 7 is not critical. However, power indicator 7 should not be so large as to add to the weight, size, or cost of the present invention without appropriate benefit. As an optional feature, power indicator 7 can be made to flash when battery 2 is weak, or in response to a clapping or voice command by an operator who has temporarily misplaced housing 11. The relative sizes and shapes of speaker 5, transmitter 4, processor 8, frequency detector 3, and radio transmission receiver 38 are also not critical, and are simply shown as one possible representation of their size and configuration. Further, the size and configuration of earpiece jack 6 is not critical as long as it allows a firm connection of an earpiece, such as the male speaker/earphone plug 12, shown in FIG. 4. FIG. 1 further shows electrical wiring 28 connected between processor 8 and battery 2, power indicator 7, speaker 5, transmitter 4, earpiece jack 6, frequency detector 3, radio transmission receiver 38, power/volume control 9, speaker/earpiece switch 10, and frequency detector activation button 1.

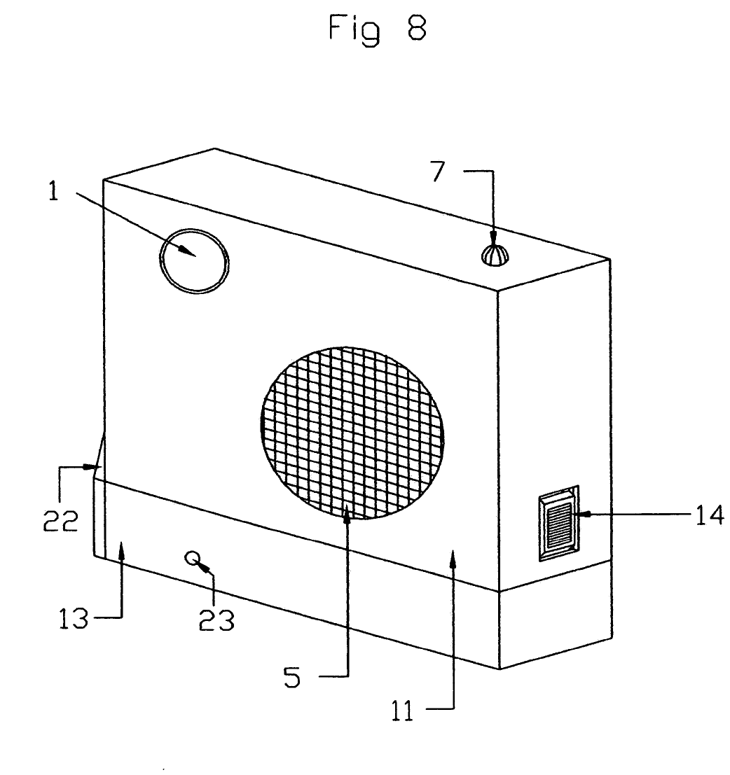

FIG. 2 shows a second preferred embodiment of the present invention with automatic frequency detection. FIG. 2 shows the second preferred embodiment of the present invention having substantially the same components as are shown in FIG. 1, to include housing 11, battery 2, battery mount 29, electrical wiring 28, power indicator 7, speaker 5, transmitter 4, processor 8, earpiece jack 6, frequency detector 3, radio transmission receiver 38, power/volume control 9, speaker/earpiece switch 10, and frequency detector activation button 1. Battery 2 may be rechargeable and either a separate component (not shown), the power device represented by battery 2, or battery mount 29 may be configured to function as a charger when plugged into an external power source to repeatedly renew the available power supply in battery 2. Although not shown, use of a charger would also necessitate the use of a power jack and/or power converter. In addition, FIG. 2 shows a detachable housing 13 secured against the bottom portion of housing 11, within which a self-winding earpiece can be stored, such as that shown in FIG. 4. FIG. 2 further shows detachable housing 13 having the male lobe 14 of a fastening device (shown in greater detail in FIG. 4), which is employed to engage female fastening device 27 (shown more clearly in FIG. 7), which are joined together as shown in FIG. 8 to securely fix detachable housing 13 against the bottom surface of housing 11 during operation. Additionally, FIG. 2 shows male speaker/earphone plug 12 positioned within earpiece jack 6, earpiece cord port 23 positioned through detachable housing 13 near its bottom surface, and a flexible end piece 22 extending upwardly from the top surface of detachable housing 13 on the opposite end from male lobe 14 in a position to cover the open end of earpiece jack 6. The configurations and dimensions of male lobe 14, male speaker/earphone plug 12, and earpiece jack 6 are not limited to that shown in FIG. 2. Further, the positioning of earpiece cord port 23 can be anywhere on detachable housing 13 where it is convenient, easy to use, and/or cost efficient to place it.

FIG. 3 shows a third preferred embodiment of the present invention configured for manual frequency detection. FIG. 3 shows the third preferred embodiment of the present invention having substantially the same components that are illustrated in FIG. 2 to include housing 11, battery 2, battery mount 29, electrical wiring 28, power indicator 7, speaker 5, transmitter 4, processor 8, earpiece jack 6, power/volume control 9, speaker/earpiece switch 10, frequency detector activation button 1, radio transmission receiver 38, detachable housing 13, male lobe 14, earpiece cord port 23, male speaker/earphone plug 12, earpiece jack 6, and flexible end piece 22. However, it is not contemplated for the configuration of all of the above-identified components in the third embodiment of the present invention to be limited to that shown in FIG. 3, or to the relative size and positioning displayed therein. The third embodiment of the present invention may also have a battery 2 that is rechargeable. A charger adapted for renewing the available power supply in battery 2 when plugged into an external power source may also be incorporated with housing 11, either as an independent component (not shown), as a part of the power supply device represented by battery 2, or as a part of battery mount 29. A power jack and/or power converter may also be used with the charger. Differences between the second and third preferred embodiments relate to the fact that the second preferred embodiment shown in FIG. 2 has a frequency detector 3 for automatic frequency detection, while in the third preferred embodiment of the present invention a frequency pre-programmed into the receiver unit must be manually selected by the operator to match the frequency of the baby monitoring system transmitter selected for use. As a result, FIG. 3 does not include a frequency detector 3, but instead has an LED display 26 that is employed to display frequency codes during synchronization of the receiving unit frequency to that of the signal transmitted by the baby monitoring system transmitter selected for use. Although a rectangular configuration is shown for LED display 26, its configuration is not critical. The location of LED display 26 is also not critical, and can be placed in any convenient and cost efficient location on housing 11.

FIG. 4 shows the most preferred embodiment of the detachable housing 13 and self-winding earpiece that includes an earphone 16, an earphone cord 21 connected between earphone 16 and male speaker/earphone plug 12, with earphone cord 21 extending through earpiece cord port 23 in detachable housing 13, the earphone cord 21 also extending through a winding guide 20, a shaft 30 positioned between a winding device 15 and a shaft block 18, a first winder bushing 19 positioned adjacent to shaft block 18, a second winder bushing 19 positioned adjacent to winding device 15, and a worm screw 17 also connected between winding device 15 and shaft block 18. FIG. 4 also shows the male lobe 14 and flexible end piece 22 which aide in the connection of detachable housing 13 to housing 11. Although not limited thereto, flexible end piece 22 may be made from rubber materials. The self-winding earpiece of the present invention may also include other variations and combinations of features without departing from the overall intent of the present invention as long as all components are small, lightweight, and compact in design for convenient and comfortable use by an operator.

FIGS. 5 and 6 show the exterior surfaces of the first preferred embodiment of the present invention configured as a pager, wherein automatic frequency detection can be accomplished simply by operator activation of frequency detector button 1 on the front of housing 11. While frequency director button 1 is not limited to the positioning shown in FIG. 6, it should be positioned for easy operator access. FIG. 5 shows the rear, top, and left side of the present invention, with power indicator 7 on the top of housing 11, a belt attachment device 24 on the rear of housing 11, and speaker/earphone switch 10, power/volume control 9, and speaker/earphone jack 6 all located on the left of housing 11 in a vertically stacked orientation with speaker/earphone switch 10 above the others, and speaker/earphone jack 6 in the lowermost position. In contrast, FIG. 6 shows the front, top, and left side of the present invention, with power indicator 7 on the top of housing 11, a frequency detector button 1 and a speaker 5 on the front of housing 11, and speaker/earphone switch 10, power/volume control 9, and speaker/earphone jack 6 all located on the left side of housing 11 in a vertically stacked orientation with speaker/earphone switch 10 above the others, and speaker/earphone jack 6 in the lowermost position. When housing 11 is mounted on the upper edge of a belt (not shown) or a clothing waistband (not shown), the positioning of power indicator 7 on the top of housing 11 makes it easily visible to the operator so that he or she is instantly made aware of low power reserves in battery 2 and when the operator is exceeding the maximum communication range of the associated baby monitoring system transmitter. Also, the positioning of frequency detector button 1 on the front of housing 11, instead of on the top of housing 11, places it in an easily accessible position for readily available use, but not one in which frequency detector button 1 would be at risk for frequent unintentional activation. Placing speaker/earphone switch 10 and power/volume control 9 on the side of housing 11, is also preferred for the same reasoning provided immediately above for the positioning of frequency detector button 1, and the positioning of speaker 5 on the front of housing 11 places it in a prominent location for effective operation. However, the configurations, size, and relative positioning of components shown in FIGS. 5 and 6 are not critical, and may vary from those shown therein. Belt attachment device 24 in FIG. 5 is configured as a spring clip, and may be rapidly clipped onto and released from the top edge of a belt, waistband, pocket, or waist-encircling strap for clothing or an accessory, such as that of a fanny pack or camera bag. However, although not shown, it is contemplated for belt attachment device 24 to have any other configuration that makes it easily secured to and removed from the person or clothing of its operator, such as a clip or hook that rearwardly depends from the top surface of housing 11. In FIGS. 5 and 6, speaker/earphone switch 10 appears to be a sliding type of switch, power/volume control 9 appears to be rotatable without ridges, and speaker/earphone jack 6 appears smaller in size than speaker/earphone switch 10 and power/volume control 9. However, other variations of configuration, placement, and size are also considered a part of the present invention.

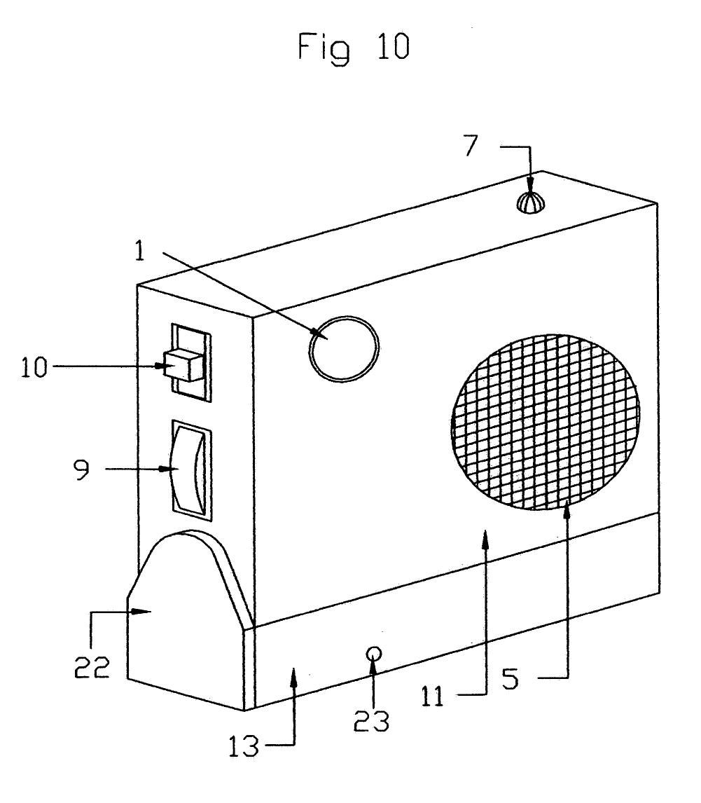

FIGS. 7-10 show the exterior surfaces of the second preferred embodiment of the present invention configured as a pager, wherein frequency detection is also automatic. FIG. 7 shows the front, top, and right side of housing 11 in the second preferred embodiment with power indicator 7 on the top of housing 11, frequency detector button 1 and speaker 5 on the front of housing 11, and female fastening device 27 on the right side of housing 11 that is used in combination with male lobe 14 to secure detachable housing 13 against the bottom surface of housing 11. In contrast, FIG. 8 shows detachable housing 13 connected against the bottom surface of housing 11 in the second preferred embodiment with power indicator 7 on the top of housing 11, frequency detector button 1 and speaker 5 on the front of housing 11, earpiece cord port 23 for a self-winding earpiece on the front of detachable housing 13, flexible end piece 22 secured between detachable housing 13 and the left side of housing 11, and male lobe 14 fixed within female fastening device 27 on the right side of housing 11 whereby detachable housing 13 is secured against the bottom surface of housing 11. Flexible end piece 22 protects male speaker/earphone plug 12 and speaker/earphone jack 6 during use and helps to secure the connection between detachable housing 13 and housing 11. FIG. 9 shows the rear, top, and left side of housing 11 in the second preferred embodiment of the present invention, with power indicator 7 on the top of housing 11, a belt attachment device 24 on the rear of housing 11, detachable housing 13 secured against the bottom surface of housing 11, speaker/earphone switch 10 and power/volume control 9 located on the left side of housing 11 in a vertically stacked orientation with speaker/earphone switch 10 above power/volume control 9, and the lower portion of flexible end piece 22 depending from detachable housing 13 and the upper portion of flexible end piece 22 secured against the left side of housing 11 below power/volume control 9. FIG. 10 shows the front, top, and left side of housing 11 in the second preferred embodiment of the present invention, with power indicator 7 on the top of housing 11, frequency detector button 1 and speaker 5 on the front of housing 11, detachable housing 13 secured against the bottom surface of housing 11, earpiece cord port 23 through the front of detachable housing 13, speaker/earphone switch 10 and power/volume control 9 located on the left side of housing 11 in a vertically stacked orientation with speaker/earphone switch 10 above power/volume control 9, and the lower portion of flexible end piece 22 depending from detachable housing 13 and the upper portion of flexible end piece 22 secured against the left side of housing 11 below power/volume control 9. The configurations, size, and relative positioning of components shown in FIGS. 7-10 are not critical, and may vary from those shown therein. Also, housing 11 may have other pager-like configurations, as well as the configurations of other small, lightweight, and easily portable objects that can be adapted with a fastening means configured for attaching it to the user, or to the clothing and/or accessories carried by the user. Such configurations may include a writing implement, such as but not limited to the pen illustrated in FIG. 13, a piece of jewelry such as but not limited to that illustrated in FIG. 14, a personal digital assistant (PDA), a cell phone, and a pocket watch or other similar sized object supported by a chain. Although belt attachment device 24 in FIG. 9 is configured as a spring clip, it may have any other configuration that makes it easily secured to and removed from the person, clothing, or accessories of its operator (not shown). Further, other variations of configuration, placement, and size for speaker/earphone switch 10, power/volume control 9, flexible end piece 22, power indicator 7, and detachable housing 13 are also considered to be a part of the present invention.

FIG. 11 shows the exterior surfaces of the third preferred embodiment of the present invention configured as a pager, wherein manual frequency synchronization between the receiving unit of the present invention and the transmitter of the selected baby monitoring unit selected for use is required. FIG. 11 shows the front, top, and right side of the present invention configured as a pager and showing a detachable housing for a self-winding earpiece secured against the bottom surface of the pager housing. FIG. 11 shows the front, top, and right side of housing 11 in the third preferred embodiment with power indicator 7 on the top of housing 11, frequency detector button 1, speaker, and LED display 26 on the front of housing 11, and female fastening device 27 on the right side of housing 11 with male lobe exposed therethrough, the combination of which are used to secure detachable housing 13 against the bottom surface of housing 11. FIG. 11 further shows earpiece cord port 23 for a self-winding earpiece on the front of detachable housing 13 and flexible end piece 22 secured between detachable housing 13 and the left side of housing 11. Although the attachment of detachable housing 13 to the bottom of housing 11 is preferred, which then dictates the general positioning of flexible end piece 22, male lobe 14, and female fastening device 27 close to that shown in FIG. 11, the positioning of power indicator 7, frequency detector button 1, LED display 26, and speaker 5 can be different from that shown in FIG. 11.

FIGS. 12-14 shows alternative housings for the present invention receiving unit. FIG. 12 shows a fourth preferred embodiment of the present invention as an all-inclusive earphone/receiver unit, having a non-self-winding earpiece 33 separated from a main body housing 11 via a sound channel 31. FIG. 12 further shows the fourth preferred embodiment having a processor 8 connected via electrical wiring 28 to internal speaker 34, battery 2, frequency detector 3, on/off switch 32, power/volume control 9, frequency detector button 1, and radio transmission receiver 38. However, the configurations, size, and relative positioning of components shown in FIG. 12 are not critical, and may vary from those shown therein. Although not shown, it is further contemplated that the all-inclusive earphone/receiver unit in the fourth preferred embodiment of the present invention could be dimensioned sufficiently small to fit substantially within the outer ear, similar to the positioning of a hearing aid, even though it is admitted that with current technology such a small unit would be complicated to build. At a minimum, the all-inclusive receiving unit must pick up the signal of the baby monitoring system transmitter (not shown), or be set to it, and then transmit the signal to the user through internal speaker 34, or a remote speaker (not shown). If a remote speaker is used, it may be attached to the ear bud via electrical wiring 28. The fourth embodiment of the present invention may also have a rechargeable battery 2, and a charger in the form of an independent component (not shown), the power supply device represented by battery 2, or battery mount 29. The use of a power jack and/or power converter is also considered to be within the scope of the fourth embodiment.

FIG. 13 shows a fifth preferred embodiment of the present invention configured as a writing implement, and FIG. 14 shows a sixth preferred embodiment of the present invention configured as a piece of jewelry, such as a bracelet. The configurations, size, and relative positioning of components shown in FIGS. 13 and 14 are not critical, and may vary from those shown therein. Also, the configuration and dimension of each housing used in FIGS. 13 and 14 are not critical, as long as it remains hands-free and is made from lightweight materials. FIGS. 13 and 14 respectively show the fifth and sixth preferred embodiments each having a housing 11, and a processor 8 connected via electrical wiring 28 to a battery 2, a radio transmission receiver 38, on/off switch 32, and frequency detector 3. In addition, FIG. 13 shows ink cartridge 35 connected to one end of housing 11 and a speaker/earphone jack 6 connected to the opposing end of housing 11, as well as battery mount 29 supporting battery 2, and volume control 9 and frequency detector button 1 connected via electrical wiring 28 to processor 8. FIG. 14 also shows housing 11 connected to a jewelry/watch band 36, a transmitter connected via electrical wiring 28 to processor 8, and an optional digital display with watch components 37. The fifth and sixth preferred embodiments could also optionally have a small LED screen 26. Since the sixth preferred embodiment shown in FIG. 14 does not have a speaker 5 or internal speaker 34, it must be used with a device having speaker means, such as the earphone illustrated in FIG. 15. The fifth and sixth embodiments of the present invention may also have a rechargeable battery 2, and a charger in the form of an independent component (not shown), the power supply device represented by battery 2, or incorporated into battery mount 29. A power jack and/or power converter may also be optionally used.

FIG. 15 shows an earphone/receiver unit, having a non-self-winding earpiece 33 separated from a main body housing 11 via a sound channel 31. A processor 8 is connected via electrical wiring 28 to internal speaker 34, battery 2, on/off switch 32, power/volume control 9, and radio transmission receiver 38. However, the configurations, size, and relative positioning of components shown in FIG. 15 are not critical, and may vary from those shown therein. The earphone/receiver unit shown in FIG. 15 could be dimensioned sufficiently small to fit substantially within the outer ear, similar to the positioning of a hearing aid, even though it is admitted that with current technology such a small unit would be complicated to build. Since the earphone/receiver unit has no frequency detector 3 to pick up the signal of the baby monitoring system transmitter (not shown), or be set to it, the earphone/receiver unit uses radio transmission receiver 38 to pick up a signal from a companion unit, such as but not limited to the sixth preferred embodiment shown in FIG. 14 as a piece of jewelry, and then transmits the signal to the user through internal speaker 34, or a remote speaker (not shown). If a remote speaker is used, it may be attached to the ear bud via electrical wiring 28. The earphone/receiver unit shown in FIG. 15 may also optionally have a rechargeable battery 2, a power jack and/or power converter (not shown), and/or a charger for renewing the available power in battery 2 provided in the form of an independent component (not shown), the power supply device represented by battery 2, or an enhanced battery mount 29.

Although not shown, it is contemplated for the present invention to incorporate infrared detection technology, or any other technology used in the future for communication between the transmitter and the original receiving unit of a baby monitoring system. The system may also have means other than visual power indicator 7, such as audio or vibration, to alert the operator to a weak signal, such as when the operator takes the receiving unit beyond its recommended range, or when battery power is low. Further, although not shown, the receiving unit of the present invention can have a locator option, so that it will produce an audible sound, or engage visual power indicator 7 in a fixed or flashing mode, when the operator claps or activates a complementary device, such as a small electronic device that may be easily carried on a key chain.

1. A hands-free, portable receiver assembly for use with the transmitters of a broad range of baby monitoring systems, said receiver assembly comprising a receiver unit comprising a compact and lightweight housing means; processor means, power indicator means, speaker means, speaker-earphone jack means, speaker-earphone switching means, transmitter means, transmission receiver means, volume control means, and electrical wiring between said processor means and said power indicator means, said speaker means, said speaker-earphone jack means, said speaker-earphone switching means, said transmitter means, said transmission receiver means, and said volume control means; said receiver unit also comprising pick-up means adapted for allowing said receiver unit to pick up signals from the transmitter of a baby monitoring system selected for use, and wherein said pick-up means is selected from a group consisting of a frequency detector, and pre-programmed baby monitoring system frequencies from which an operator is able to select one thereof to manually match the frequency of said the baby monitoring system transmitter selected for use; and said receiver unit further comprising electrical power supply means adapted for powering said processor so that when the transmitter of a baby monitoring system sends out a signal, said receiving unit can pick up the signal and transmit it to a user needing to monitor a person in the vicinity of the baby monitoring system transmitter.

2. The receiver assembly of claim 1 further comprising an earpiece.

3. The receiver assembly of claim 2 wherein said earpiece is self-winding.

4. The receiver assembly of claim 3 wherein said self-winding earpiece comprises a shaft, a worm screw, a winder guide, and a winding device connected to said shaft and said worm screw.

5. The receiver assembly of claim 3 further comprising a detachable housing having adequate interior dimension to contain said self-winding earpiece.

6. The receiver assembly of claim 5 wherein said detachable housing comprises a fastening means adapted for connection to said lightweight housing means, and wherein said detachable housing further comprises an earpiece cord port.

7. The receiver assembly of claim 1 wherein said lightweight housing means is selected from a group consisting of housings worn by an operator, housings attachable to the clothing of an operator, housings attachable to the belt of an operator, housings attachable to the waistband of an operator's clothing; housings configured as a writing implement, housings configured as a piece of jewelry, housings configured as a pager, housings configured as an all-inclusive stand-alone earpiece, and housings configured solely as an earphone/receiver unit that are usable only in combination with a second one of said housings having a frequency detector.

8. The receiver assembly of claim 7 wherein said stand-alone earpiece is selected from a group consisting of earpieces having a built-in speaker, earpieces having a distinct ear bud housing a speaker, earpieces having a distinct ear bud housing a speaker that communicates with the associated earpiece via electrical wiring, and earpieces having a distinct ear bud housing a speaker that communicates with the associated earpiece via a sound channel.

9. The receiver assembly of claim 1 wherein said pick-up means comprises a frequency detector and a frequency detector button.

10. The receiver assembly of claim 1 wherein said pick-up means comprises pre-programmed baby monitoring system frequencies and an LED display.

11. The receiver assembly of claim 1 wherein said processor further comprises a capability for providing a locator signal to an operator remotely located from said receiver assembly and whereby said locator signal is produced in response to an operator generated command.

12. The receiver assembly of claim 1 wherein said electrical power supply means is selected from a group consisting of external alternating current electrical power sources, external direct current electrical power sources, disposable batteries, rechargeable batteries, power supply devices that function as a charger when plugged into an external power source, power supplies that include one or more power jacks, and power supplies that include one or more power converters.

13. A method for manufacturing a receiver assembly that is usable with the transmitters of a broad range of baby monitoring systems, method comprising the steps of:
providing a compact lightweight housing, a speaker, a processor, a transmitter, a power supply, a power indicator, frequency pick-up means, a volume control, a speaker-earphone jack, a speaker-earphone switch, transmission receiver means, and electrical wiring;
positioning said speaker, said power indicator, said volume control, said speaker-earphone jack, and said speaker-earphone switch through said housing;
placing said processor, said transmitter, said transmission receiver means and said power supply within said housing;
installing said frequency pick-up means within said housing;
using a portion of said electrical wiring to electrically connect said processor to said power supply; and
also using a portion of said electrical wiring to electrically connect said processor to said power indicator means, said speaker, said speaker-earphone jack, said speaker-earphone switch, said volume control, said transmitter, said transmission receiver means, and said frequency pick-up means so that when the transmitter of a baby monitoring system sends out a signal, said receiving assembly can pick up the signal and transmit it to a user needing to monitor a person in the vicinity of the baby monitoring system transmitter.

14. The method of claim 13 further comprising the steps of providing an earpiece and securing said earpiece to said speaker-earphone jack.

15. The method of claim 14 wherein said earpiece is self-winding and comprises a shaft, a worm screw, a winder guide, and a winding device connected to said shaft and said worm screw.

16. The method of claim 15 further comprising the steps of providing a detachable housing having adequate interior dimension to contain said self-winding earpiece and securing said detachable housing to said housing.

17. The method of claim 16 wherein said detachable housing comprises an earpiece cord port.

18. The method of claim 13 wherein said housing is selected from a group consisting of housings worn by an operator, housings attachable to the clothing of an operator, housings attachable to the belt of an operator, housings attachable to the waistband of an operator's clothing; housings configured as a writing implement, housings configured as a piece of jewelry, housings configured as a pager, housings configured as an all-inclusive stand-alone earpiece, and housings configured solely as an earphone/receiver unit that are usable only in combination with a second one of said housings having a frequency detector.

19. The method of claim 18 wherein said stand-alone earpiece is selected from a group consisting of earpieces having a built-in speaker, earpieces having a distinct ear bud housing a speaker, earpieces having a distinct ear bud housing a speaker that communicates with the associated earpiece via electrical wiring, and earpieces having a distinct ear bud housing a speaker that communicates with the associated earpiece via a sound channel.

20. The method of claim 13 wherein said pick-up means is selected from a group consisting of pick-up means having a frequency detector and a frequency detector button, and pick-up means having pre-programmed baby monitoring system frequencies and an LED display.

21. The method of claim 13 wherein said processor further comprises a capability for providing a locator signal to an operator remotely located from said receiver assembly and whereby said locator signal is produced in response to an operator generated command.

22. The method of claim 13 wherein said power supply is selected from a group consisting of external alternating current electrical power sources, external direct current electrical power sources, disposable batteries, rechargeable batteries, power supply devices that function as a charger when plugged into an external power source, power supplies that include one or more power jacks, and power supplies that include one or more power converters.
